(19) United States
(12) Patent Application Publication
(10) Pub. No.: US 2025/0323692 A1
(43) Pub. Date: Oct. 16, 2025

(54) SYSTEM AND METHOD FOR AN INTEGRATED MASSIVE MIMO RADIO UNIT

(71) Applicant: JIO PLATFORMS LIMITED, Ahmedabad (IN)

(72) Inventors: Deepak GUPTA, Navi Mumbai (IN); Nekiram KHOSYA, Dombivali (E) (IN); Renuka R., Dombivali East (IN); Amrish BANSAL, Navi Mumbai (IN)

(73) Assignee: JIO PLATFORMS LIMITED, Ahmedabad (IN)

(21) Appl. No.: 18/881,664

(22) PCT Filed: Dec. 27, 2023
(86) PCT No.: PCT/IB2023/063273

§ 371 Date: Jan. 6, 2025

(30) Foreign Application Priority Data
Jan. 31, 2023 (IN) 202321006379

(51) Int. Cl. H04B 7/0413; H04B 1/40

(52) U.S. Cl. CPC H04B 7/0413; H04B 1/40

(57) ABSTRACT

The present disclosure relates to an open radio access network (ORAN) compliant 5G massive integrated multiple-input multiple-output (MIMO) radio unit (IMRU) where a High-Speed Transceiver Board (HSTB) and Radio Frequency (RF) Front End Module (RFEM) are integrated into a single board to reduce the weight and optimize the cost by eliminating the need of blind mating connectors. The IMRU is connected to a Combined Central and Distributed Unit (CCDU) on a fronthaul interface using 25G optical interface. Further, the IMRU is integrated with an Antenna Filter Unit (AFU) and covered in single enclosure for easy and efficient installation that ensures advanced beam forming while ensuring low weight and compact form factor to enable easy installation.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for wireless communication networks. More particularly, the present disclosure relates to a system and a method for a 5G new radio (NR) integrated massive multiple-input multiple-output (MIMO) radio unit that is specific to areas with high traffic and (QoS) quality of service demands.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Multiple-input multiple-output (MIMO) is a radio antenna technology that deploys one or more antennas at both transmitter and receiver ends to increase the quality, throughput, and capacity of a radio link. MIMO uses techniques known as spatial diversity and spatial multiplexing to transmit independent and separately encoded data signals, known as “streams,” reusing the same time period and frequency resource. However, existing systems pertaining to design/architecture of massive MIMO radio units (MRUs) are highly priced, high on power consumption, thermally inefficient, and bulky. Further, the existing MRUs require interoperability and coupling with various separate/currently independent/non-conformant, and cabled components such as antenna components and transceiver elements which complicates the overall design and construction.

There is, therefore, a need in the art to provide a system and a method that can mitigate the problems associated with the prior arts.

### OBJECTS OF THE PRESENT DISCLOSURE

Some of the objects of the present disclosure, which at least one embodiment herein satisfies are listed herein below.

It is an object of the present disclosure to provide a system and a method for a 5G new radio (NR) integrated massive multiple-input multiple-output (MIMO) radio unit

(IMRU) with baseband and radio frequency (RF) front end combined in a single unit, along with antenna and cavity filter integrated solution without any use of cable.

It is an object of the present disclosure to provide a 5G NR IMRU that is designed to be compact and light weight, easing installation and expanding site options while reducing operational cost.

It is an object of the present disclosure to provide a 5G NR IMRU that is quick to deploy and delivers high performance with low power consumption.

It is an object of the present disclosure to provide a 5G NR IMRU where a High-Speed Transceiver Board (HSTB) and an RF Front End Module (RFEM) are integrated into a single board with common housing and fins on one side to reduce the weight and optimize the cost by eliminating the need of blind mating connectors.

It is an object of the present disclosure to provide a 5G NR IMRU that is compatible to hold digital domain, RF domain, and analog power domain in a single board.

It is an object of the present disclosure to provide a 5G NR IMRU that is thermally efficient.

It is an object of the present disclosure to provide a 5G NR IMRU with enhanced sensitivity.

It is an object of the present disclosure to provide a 5G NR IMRU with improved system noise figure at the receiver side.

### SUMMARY

This section is provided to introduce certain objects and aspects of the present disclosure in a simplified form that are further described below in the detailed description.

This summary is not intended to identify the key features or the scope of the claimed subject matter.

In an aspect, the present disclosure provides an integrated multiple-input multiple-output (MIMO) radio unit (IMRU). The IMRU may include an integrated board including a High Speed Transceiver Board (HSTB) and a Radio Frequency (RF) Front End Module (RFEM). The integrated board may be operatively coupled to an antenna filter unit (AFU) to transmit and receive a plurality of data streams from a user equipment (UE) using a radio channel.

In an embodiment, the HSTB may be operatively coupled to a Combined Central and Distributed Unit (CCDU) on a fronthaul interface. The HSTB may include a plurality of RF transceivers to receive digital signals from the CCDU and convert the received digital signals into RF signals across a plurality of RF chains.

In an embodiment, the IMRU may be configured to generate a system noise figure of 3 dB.

In an embodiment, the RFEM may include one or more RF power amplifiers to receive and amplify said RF signals.

In an embodiment, the AFU may include an integrated MIMO antenna and a cavity filter to enable beamforming.

In an embodiment, the HSTB may include the plurality of RF transceivers to generate a bit stream of the RF signals. Further, the HSTB may include a lower layer PHY section of L1 layer and a baseband section to support a plurality of transmit and receive chains. The chains may be configured on a dense set of layers of the HSTB.

In an embodiment, the plurality of transceivers may be field programmable gate arrays (FPGAs), and the HSTB may include three FPGAs. The digital signals received from the CCDU may be converted into the RF signals using one or more first transceivers and one or more second transceivers may act as a digital frontend to process the RF signals. The RF signals may pass through one or more of Analog-to-Digital (ADC) converters and Digital-to-Analog (DAC) converters to generate analog signals that are subsequently transmitted to one or more RF connectors.

In an embodiment, the HSTB may interface with the CCDU on a predefined optical interface.

In an embodiment, an L1 higher layer may be configured on the CCDU. The CCDU may merge a central unit (CU) with a distributed unit (DU) and interface through the fronthaul interface with the IMRU.

In an embodiment, the IMRU may include a precision time protocol (PTP) based clock synchronization architecture on the fronthaul interface including system synchronizer integrated circuit (IC) and clock generators.

In an embodiment, the RFEM may include one or more low noise amplifiers (LNAs), gain blocks, and a plurality of RF switches for a plurality of transmit and receive chains that act as digital predistortion (DPD) feedback paths from power amplifiers (PAs) to FPGAs for linearization.

In an embodiment, the RFEM may include or more layers and a receiver section that receives the amplified RF signals and decodes the RF signals in the receiver section using a plurality of receivers, after which the RF signals are converted into digital signals and transmitted to upper layers having RF connectors.

In an aspect, the present disclosure provides a user equipment (UE) that may be operatively coupled with an IMRU. The UE may be configured to receive a connection request from the IMRU, send an acknowledgement of the connection request to the IMRU, and in response, transmit a plurality of data streams.

In an embodiment, an apparatus may include the IMRU, as discussed above.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary design architecture of an integrated massive multiple-input multiple-output (MIMO) radio unit (IMRU), in accordance with an embodiment of the present disclosure.

FIG. 2 illustrates an exemplary design architecture of a High Speed Transceiver Board (HSTB), in accordance with an embodiment of the present disclosure.

FIG. 3 illustrates an exemplary design architecture of a radio frequency (RF) Front End Module (RFEM), in accordance with an embodiment of the present disclosure.

FIG. 4 illustrates an exemplary coupling representation of a user equipment (UE) with the IMRU, in accordance with aspects of the present disclosure.

FIG. 5 illustrates an exemplary computer system in which or with which embodiments of the present disclosure may be implemented.

The foregoing shall be more apparent from the following more detailed description of the disclosure.

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

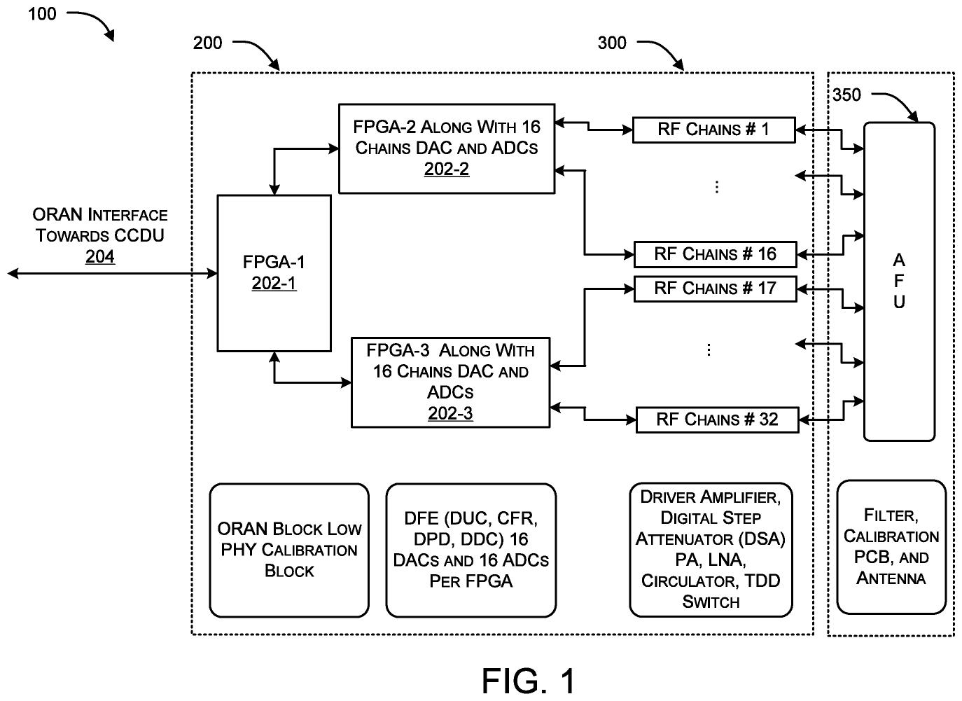

The various embodiments throughout the disclosure will be explained in more detail with reference to FIGS. 1-5.

The present disclosure relates to an open radio access network (ORAN) compliant 5G integrated massive multiple-input multiple-output (MIMO) radio unit (IMRU). Further, the present disclosure provides a hardware architecture and design of a multiple antenna configuration 32T32R based IMRU for standalone mode where the proposed 5G IMRU is a radio unit (RU) connected to a Combined Central and Distributed Unit (CCDU) on a fronthaul interface using 25G optical interface, and is compliant to Third Generation Partnership Project (3GPP) based ORAN specifications.

FIG. 1 illustrates an exemplary design architecture of a massive MIMO radio unit (IMRU), in accordance with an embodiment of the present disclosure.

As illustrated in FIG. 1, the proposed 5G IMRU 100 may include a lower PHY (Physical) portion of L1 layer with network layer split of 7.2× (O-RAN Alliance fronthaul specification between O-DU to O-RRU), a baseband section, a Radio Frequency (RF) Front End module (RFEM), and an Antenna Filter Unit (AFU) as part of a single enclosure/unit for easy and efficient installation.

In an embodiment, the proposed 5G IMRU 100 may include a High Speed Transceiver Board (HSTB) 200 having a lower layer PHY section, an ORAN compliant fronthaul on 25G optical interface 204, and a digital RF front end support for 32 transmit and receive chains using, for instance, commercial grade three field programmable gate arrays (FPGAs)/transceivers (202-1, 202-2, 202-3), collectively referred as 202. It would be appreciated that while the disclosure is being explained with respect to an FPGA, any other equivalent transceiver is fully within the scope of the present disclosure, and therefore scope of each FPGA should be treated as that of any transceiver or technically equivalent component such as an application specific integrated circuit (ASIC).

In an embodiment, the 5G NR 32T32R IMRU 100 may be a highly integrated design with baseband and RFEM combined in single unit, along with antenna and cavity filter integrated solution without any use of cable. Further, the IMRU 100 may be designed to be compact and light weight, casing installation, expanding site options, and further reducing operational costs. The IMRU 100 may be easily installed, quick to deploy, and deliver high performance with low power consumption, thus making it a power efficient solution. The IMRU 100 may be connected to a central and a distributed unit (CCDU) below the tower on a single 25G optical fronthaul interface.

In an embodiment, the 5G NR 32T32R IMRU 100 may be a highly integrated apparatus with baseband and RFEM combined in single unit, along with antenna and cavity filter integrated solution without any use of cable.

In an embodiment, the 5G NR 32T32R IMRU 100 may be thermally efficient, with an increase in the system noise figure on the receiver side from 3.6 dB to 3.0 dB. Hence, a corresponding enhancement may be observed in the sensitivity of the system.

In an exemplary embodiment, the L1 lower layer PHY development and bit stream generation may be implemented/undertaken in the FPGA 202 itself. L1 higher layer may be configured on the CCDU below the tower, wherein the L2 and L3 may be configured on the distributed unit. A macro-site typically includes a central unit node (server side) and a distributed unit node (configured between the CU and RUs). The present disclosure may merge the central unit node with the distributed unit node so as to form a CCDU that interfaces through the 25G optical interface with the RUs/IMRUs, in accordance with embodiments of the present disclosure. The IMRU 100 may further include a precision time protocol (PTP) based clock synchronization architecture on the 25G optical interface 204 using system synchronizer integrated circuit (IC) and clock generators.

In an embodiment, the IMRU 100 may further include an integrated 8×8 MIMO antenna with 32 cavity filter as a one unit known as Antenna Filter Unit (AFU) 350.

In an exemplary embodiment, the 5G IMRU 100 may be a 200 W high power gNB that may operate in macro class (typically 6.25 W or 38 dBm per antenna port) and may be configured to provide macro-level wide-area solutions for coverage and capacity that may find utility in dense urban morphologies, hot zone/hot spot areas having high traffic, and quality of service (QOS) demands. The 5G IMRU 100 may further include a lower layer PHY section, an RF transceiver based on commercial grade FPGAs for 32 transmit and receive chains (as part of the HSTB 200), a RF Front End Module (RFEM) 300 that includes RF power amplifiers, low noise amplifiers (LNA), RF switches for 32 chains, a 8*8 MIMO antenna along with 32 cavity filters known as Antenna Filter Unit (AFU) 350 as part of a single convection cooled enclosure and weighing less than 20 kg.

In an exemplary embodiment, the gNB may provide good coverage, capacity for dense urban clutter owing to 8 downlink beams and 4 uplink beams that may support under multi-user equipment (UE) scenarios. The 5G IMRU 100 may be deployed at high rise buildings, dense clutters, and hotspot locations where traffic demand is significantly high and cannot be served by 4G gNB alone for coverage and capacity boosts.

In an exemplary embodiment, the 5G IMRU 100 may be a high power gNB that operates in macro class (typically ≤38 dBm per antenna port) and may be configured to complement macro-level wide-area solutions for coverage and capacity. Further, as discussed above, the high level architecture of the proposed 32T32R 5G NR IMRU 100 may include the HSTB 200, a 32T32R RFEM 300, an AFU 350, and a mechanical housing.

In an exemplary embodiment, the proposed design architecture may include a control plane, user plane, and a synchronization plane, where the control plane may be configured to control the configuration of the units/sub-units that form part of the proposed IMRU 100 from a distance-place perspective. Further, the user plane may include user data and the synchronization plane may be configured to utilize PTP on the instant 25G interface so as to synchronize the unit/sub-units with respect to a global clock using a timing protocol (i.e. the slave device would sync its clock with the master device in terms of the phase and the frequency), and maintain consistency/sync with the CCDU.

It may be appreciated that the IMRU 100 meets all the RF performance requirements after integrating TDD based 5G NR MRU with Crest Factor Reduction (CFR) and digital pre-distortion (DPD) modules in digital front end lineup. Furthermore, the IMRU 100 may be optimally handled by the IP65 ingress protected mechanical housing.

In an embodiment of the present invention, the disclosed IMRU may be configured for system noise figure at the receiver side, for e.g.: 3 dB.

### High Speed Transceiver Board (HSTB) 200

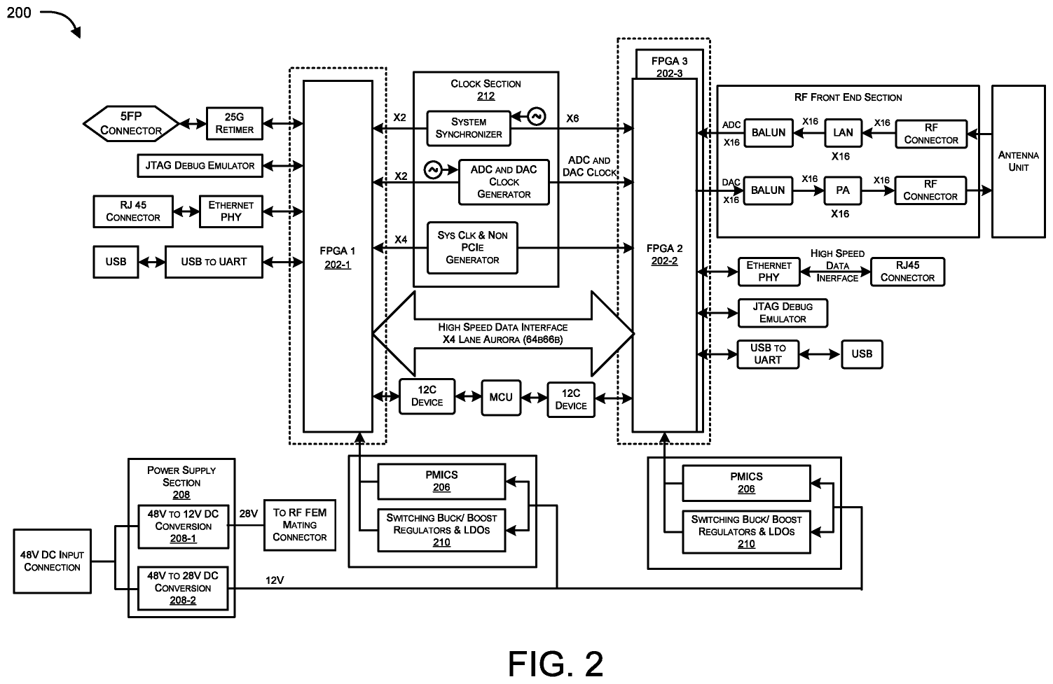

FIG. 2 illustrates an exemplary design architecture of a High Speed Transceiver Board (HSTB) 200, in accordance with an embodiment of the present disclosure.

In an exemplary embodiment, with reference to FIGS. 1 and 2, the HSTB 200 may include three (3) FPGA chipsets 202-1, 202-2, and 202-3 for lower L1 layer processing and digital front end section. The HSTB 200 may be configured to receive external −48V input DC voltage and down convert it to various lower voltages (such as to 12V and then 12V to 5V and 1V among other combinations as desired) based on requirements from different devices on board. Any or a combination of a power management integrated chipset (PMIC) 206, a power supply section 208, and LDO regulator devices 210 may be used to generate these desired voltages.

In an exemplary embodiment, the transceiver 202-1 may be configured to receive digital data/signals from the CCDU and transmitted to transceivers 202-2/202-3 which would covert the digital data into RF signals across the 32 RF chains and be operatively coupled with the clock section 212. The RFEM 300 may receive power from the HSTB 200 in order to reduce and optimize power requirements and derive as much power required from the HSTB 200 itself.

In an exemplary embodiment, the complete system may be synchronized (using, for instance, a clock/synchronization section 212) within the HSTB 200 through IEEE 1588v2 based PTP on 25G fronthaul interface while running PTP client to on board synchronization circuit. The proposed circuit may include any or a combination of ultra-low noise clock generation phase locked loop (PLLs), a programmable oscillator, and a system synchronizer.

FIG. 2 illustrates an exemplary overall design architecture of the proposed HSTB 200 that may include sub-systems including, but not limited to, FPGA based RF transceivers, digital high-speed signals, switching power supplies, clock section, and radio frequency signal that are designed on a 26 or more layer printed circuit board (PCB). The PCB design may include unique design techniques to route RF signals and aurora signals running on high speed 25GT/s on adjacent layers and meet design specifications.

In an exemplary embodiment, the HSTB 200 may be configured to obtain, through a 25 Gigabit fiber interface (exemplary), at a transceiver (such as FPGA), data from the CCDU residing on the ODC (outdoor cabinet), and process the obtained digital data to provide RF signal(s). The other two transceivers may then be configured to act as a digital frontend so as to process the high speed RF signals through Analog-to-Digital (ADC) converters and Digital-to-Analog (DAC) converters. The analog signals would then be transmitted to the RF connectors that would blind-mate with the RFEM 300.

32T32R RF Front End module (RFEM) 300

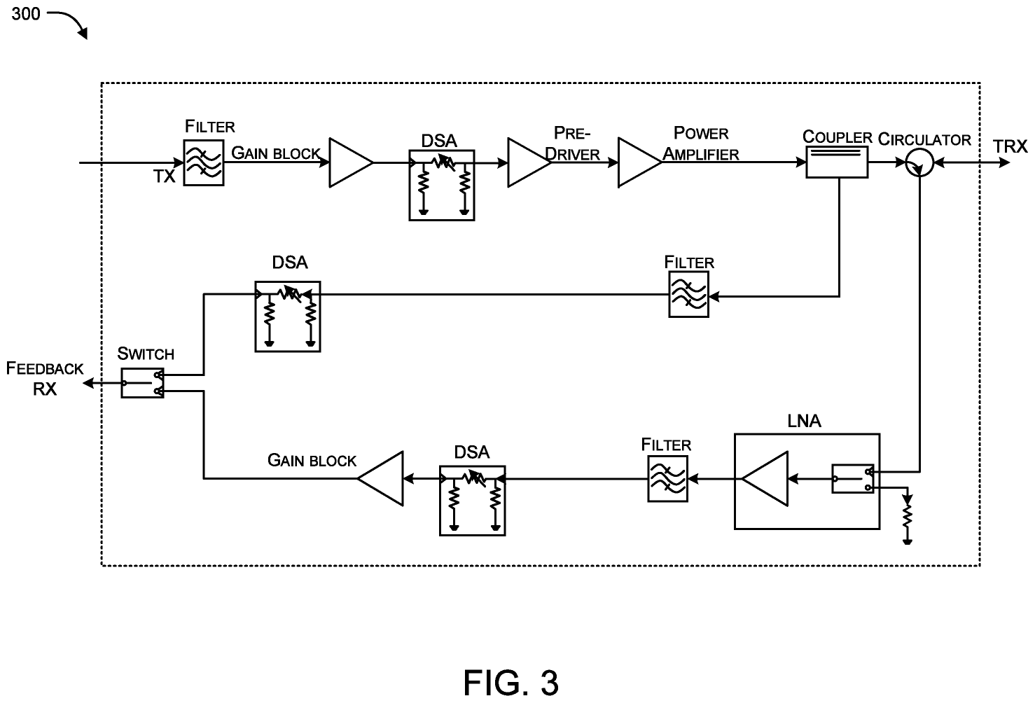

FIG. 3 illustrates an exemplary design architecture of a RF Front End Module (RFEM) 300, in accordance with an embodiment of the present disclosure.

In an exemplary embodiment, the RFEM 300 may be configured to receive control signals (RF signals) from the HSTB 200 along with a power supply through a connector. The RFEM 300 may be configured to act as a signal extended so as to incorporate 32 transmit chains for signal transmission, 32 receive chains for signal reception, and 32 observation chains that can act as Digital Predistortion (DPD) feedback paths from Power Amplifiers (PAs) to FPGAs for linearization. The RFEM 300 may using gain blocks and power amplifiers, amplify each received RF signal from the HSTB 200 across each chain so as to generate power of 6.25 Watts from each chain. Considering 32 chains that form part of the proposed RFEM 300, a cumulative power of around 200 Watts may be generated, equating to 53 dBm. Further, the transmit chain may be configured to carry matching balun, pre-driver amplification, and final RF power amplification as part of the final stage of power amplification (PA).

In an exemplary embodiment, each receive chain, on the other hand may be configured to carry low noise amplifier (LNA), band pass surface acoustic wave filter (SAW) filter, and matching network. Each observation chain may be configured to carry directional coupler, digital step attenuator (DSA), and matching network.

In an exemplary embodiment, the RFEM 300 may include 10 or more layers and may include a receiver section that can receive amplified RF signal from the 5G user equipment (UE) and decode the signals in the receiver section using 32 receivers, post which the RF signal may be converted into digital signals and transmitted to the upper layers having RF connectors.

In an exemplary embodiment, the RFEM 300 may include an RF time division duplex (TDD) switch that may combine each transmit-receive pair. Circulator and cavity filter(s) may be used between each RF switch and the antenna port.

### Antenna Filter Unit (AFU) 350

In an embodiment, the proposed AFU 350 may comprise a cavity filter and an 8*8 MIMO (128 single antenna elements) antenna unit with calibration PCB in one integrated unit known as the AFU and connected with the RFEM 300. The AFU 350 may enable beamforming, i.e. multiple antennas may be used to control the direction of a wave-front by appropriately weighting the magnitude and phase of individual antenna signals among multiple antennas. The AFU 350 may be configured to be coupled to the housing from below, where the RFEM 300 board would be placed in an aluminium metal housing having a covering on the bottom side. The AFU 350 and the RFEM 300 may be configured on the HSTB 200 along a transmission line that may be cylindrical in shape from both sides and may be connected between two connectors like a pole so that there may be two receptacles between a pillar that would connect these units/sub-units.

The proposed AFU 350 may include a 32-port (32 antenna ports as receiver and transmitter are coming to the same antenna port, where the 32 ports would be connected to corresponding/respective 32 cavity filters). The cavity filter for 32T3R configuration may provide steeper roll-off outside operating band. Hence, the AFU 350 may enable unique radiation pattern, low loss, and lower interferences.

In an exemplary embodiment, the proposed IMRU 100 may be able to reduce system noise figure levels owing to the design and layout of the IMRU architecture.

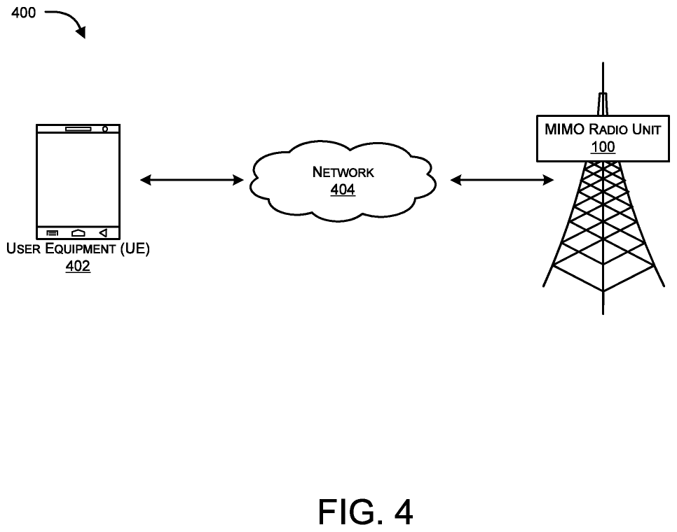

FIG. 4 illustrates an exemplary coupling representation 400 of a user equipment (UE) with the IMRU, in accordance with aspects of the present disclosure.

As illustrated, the UE 402 may be communicatively coupled to the IMRU 100 through a network 404. In an exemplary embodiment, the network 404 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The UE 402 may be any handheld device, mobile device, palmtop, laptop, smart phone, pager and the like. As a result of connecting with the IMRU 100, the UE 402 may be configured to receive a connection request from the IMRU 100. Further, the UE 402 may send an acknowledgement of the connection request and enable communication with the IMRU 100 by transmitting and/or receiving a plurality of data streams.

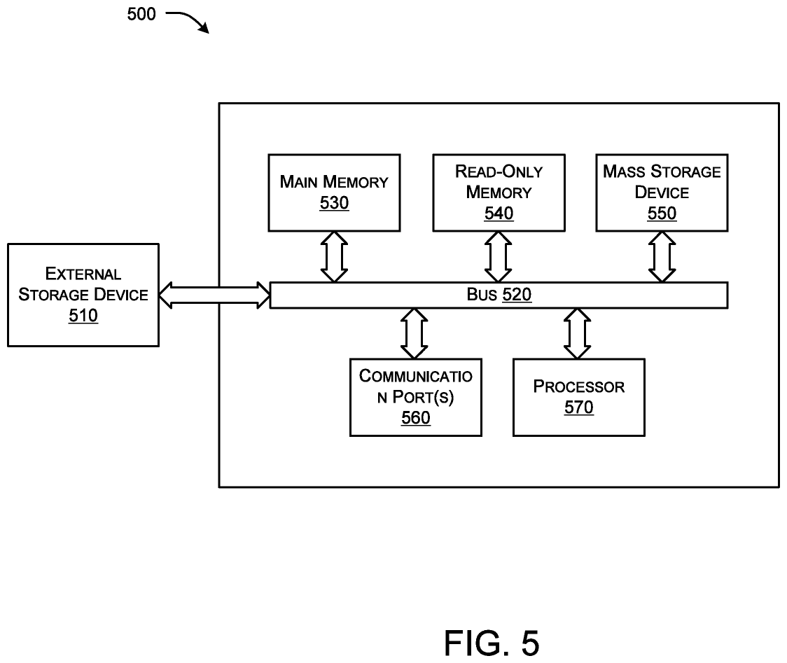

FIG. 5 illustrates an exemplary computer system 500 in which or with which embodiments of the present disclosure may be implemented.

As shown in FIG. 5, the computer system 500 may include an external storage device 510, a bus 520, a main memory 530, a read-only memory 540, a mass storage device 550, a communication port(s) 560, and a processor 570. A person skilled in the art will appreciate that the computer system 500 may include more than one processor and communication ports. The processor 570 may include various modules associated with embodiments of the present disclosure. The communication port(s) 560 may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) 560 may be chosen depending on a network, such as a Local Area Network (LAN), Wide Area Network (WAN), or any network to which the computer system 500 connects.

In an embodiment, the main memory 530 may be Random Access Memory (RAM), or any other dynamic storage device commonly known in the art. The read-only memory 540 may be any static storage device(s) e.g., but not limited to, a Programmable Read Only Memory (PROM) chip for storing static information e.g., start-up or basic input/output system (BIOS) instructions for the processor 570. The mass storage device 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus 520 may communicatively couple the processor(s) 470 with the other memory, storage, and communication blocks. The bus 520 may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor 570 to the computer system 500.

In another embodiment, operator and administrative interfaces, e.g., a display, keyboard, and cursor control device may also be coupled to the bus 520 to support direct operator interaction with the computer system 500. Other operator and administrative interfaces can be provided through network connections connected through the communication port(s) 560. Components described above are meant only to exemplify various possibilities. In no way should the aforementioned exemplary computer system 500 limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method for a 5G new radio (NR) integrated massive multiple-input multiple-output radio unit (IMRU) with baseband and radio frequency (RF) front end combined in single unit, along with antenna and cavity filter integrated solution without any use of cable.

The present disclosure provides a system that integrates time division duplex (TDD) based 5G NR IMRU with Crest Factor Reduction (CFR) and Digital Pre-Distortion (DPD) modules in Digital Front End lineup.

The present disclosure provides an IMRU with low power consumption and an IP65 ingress protected mechanical housing for optimally handling thermal requirements.

The present disclosure provides an IMRU that is compact, lightweight, and enables easy installation.

The present disclosure provides a 5G NR IMRU where a High-Speed Transceiver Board (HSTB) and an RF Front End Module (RFEM) are integrated into a single board with common housing and fins on one side to reduce the weight and optimize the cost by eliminating the need of blind mating connectors.

The present disclosure reduces the Latency and increases the reliability of the network.

The present disclosure increases the data rate and capacity of wireless systems.

The present disclosure provides 5G NR IMRU that is compatible to hold digital domain, RF domain, and analog power domain in a single board.

The present disclosure provides 5G NR IMRU that is thermally efficient.

The present disclosure provides 5G NR IMRU with enhanced sensitivity.

The present disclosure provides 5G NR IMRU with improved system noise figure at the receiver side.

We claim:

1. An integrated multiple input multiple output (MIMO) radio unit (IMRU), comprising:
an integrated board comprising a High Speed Transceiver Board (HSTB) (200) and a Radio Frequency (RF) Front End Module (RFEM) (300), wherein the integrated board is operatively coupled to an antenna filter unit (AFU) (350) to transmit and receive a plurality of data streams from a user equipment (UE) using a radio channel.

2. The IMRU as claimed in claim 1, wherein the HSTB (200) is operatively coupled to a Combined Central and Distributed Unit (CCDU) on a fronthaul interface, said HSTB (200) comprising a plurality of RF transceivers to receive digital signals from the CCDU and convert the received digital signals into RF signals across a plurality of RF chains.

3. The IMRU as claimed in claim 1, wherein the IMRU is configured to generate a system noise figure of 3 dB.

4. The IMRU as claimed in claim 2, wherein the RFEM (300) comprises one or more RF power amplifiers to receive and amplify said RF signals.

5. The IMRU as claimed in claim 1, wherein the AFU (350) comprises an integrated MIMO antenna and a cavity filter to enable beamforming.

6. The IMRU as claimed in claim 2, wherein the HSTB (200) comprises:
the plurality of RF transceivers to generate a bit stream of the RF signals;
a lower layer PHY section of L1 layer; and
a baseband section to support a plurality of transmit and receive chains, said chains being configured on a dense set of layers of the HSTB (200).

7. The IMRU as claimed in claim 6, wherein the plurality of RF transceivers are field programmable gate arrays (FPGAs), and wherein the HSTB (200) comprises a plurality of FPGAs, and wherein the digital signals received from the CCDU are converted into the RF signals using one or more first transceivers, and one or more second transceivers act as a digital frontend to process the RF signals through one or more of Analog-to-Digital (ADC) converters and Digital-to-Analog (DAC) converters to generate analog signals that are subsequently transmitted to one or more RF connectors.

8. The IMRU as claimed in claim 2, wherein the HSTB (200) interfaces with the CCDU on a pre-defined optical interface.

9. The IMRU as claimed in claim 6, wherein an L1 higher layer is configured on the CCDU, and wherein the CCDU merges a central unit (CU) with a distributed unit (DU) and interfaces through the fronthaul interface with the IMRU.

10. The IMRU as claimed in claim 2, comprising a clock synchronization module on the fronthaul interface, wherein the clock synchronization module comprises a system synchronizer integrated circuit (IC) and clock generators.

11. The IMRU as claimed in claim 1, wherein the RFEM (300) comprises one or more low noise amplifiers (LNAs), gain blocks, and a plurality of RF switches for a plurality of transmit and receive chains that act as digital predistortion (DPD) feedback paths from power amplifiers (PAs) to field programmable gate arrays (FPGAs) for linearization.

12. The IMRU as claimed in claim 4, wherein the RFEM (300) comprises one or more layers and a receiver section that receives the amplified RF signals and decodes the RF signals in the receiver section using plurality of receivers, after which the RF signals are converted into digital signals and transmitted to upper layers having RF connectors.

13. A user equipment (UE) (402) operatively coupled with an IMRU (100), the UE (402) configured to:
receive a connection request from the IMRU (100);
send an acknowledgement of the connection request to the IMRU (100); and
in response, transmit a plurality of data streams,
wherein the IMRU (100) comprises:
an integrated board comprising a High Speed Transceiver Board (HSTB) (200) and a Radio Frequency (RF) Front End Module (RFEM) (300), wherein the integrated board is operatively coupled to an antenna filter unit (AFU) (350) to transmit and receive the plurality of data streams from UE (402) using a radio channel.

14. An apparatus comprising the integrated multiple input multiple output (MIMO) radio unit (IMRU) as claimed in claim 1.
